(19) United States
(12) Patent Application Publication
(10) Pub. No.: US 2021/0246934 A1
(43) Pub. Date: Aug. 12, 2021

(54) CRANKSHAFT OIL SUPPLY STRUCTURE

(71) Applicants: HYUNDAI MOTOR COMPANY, Seoul (KR); KIA MOTORS CORPORATION, Seoul (KR)

(72) Inventors: Jeong Soo SHIN, Hwaseong-si (KR); Doeon KIM, Bucheon-si (KR)

(73) Assignees: HYUNDAI MOTOR COMPANY, Seoul (KR); KIA MOTORS CORPORATION, Seoul (KR)

(21) Appl. No.: 17/023,653

(22) Filed: Sep. 17, 2020

(30) Foreign Application Priority Data
Feb. 12, 2020 (KR) 10-2020-0016950

(51) Int. Cl. F16C 3/14; F16C 9/02; F01M 1/06

(52) U.S. Cl. CPC F16C 3/14; F01M 2001/062; F16C 9/02

(57) ABSTRACT

A crankshaft oil supply structure includes: an upper engine block having upper end saddles positioned at both ends thereof and an upper crank saddle positioned between the upper end saddles; a lower engine block formed with a plurality of lower crank saddle; an upper end bearing formed with an end bearing hole and mounted on each of the upper end saddles; an upper main bearing formed with a main bearing hole and mounted on the upper crank saddle; a lower bearing mounted on each lower crank saddle of the plurality of lower crank saddles; and a crankshaft formed with an end journal supported by the upper end bearing, a main bearing journal supported by the upper main bearing, and a crank pin journal. In particular, the main bearing hole is larger than the end bearing hole.

### CROSS-REFERENCE TO RELATED APPLICATION

This application claims priority to and the benefit of Korean Patent Application No. 10-2020-0016950, filed on Feb. 12, 2020, the entire contents of which are incorporated herein by reference.

### FIELD

The present disclosure relates to a crankshaft oil supply structure. More particularly, the present disclosure relates to a crankshaft oil supply structure to improve oil supply.

### BACKGROUND

The statements in this section merely provide background information related to the present disclosure and may not constitute prior art.

A crankshaft along with a connecting rod is a rotation shaft that converts a reciprocal motion of a piston into a rotational motion. The crankshaft is commonly used in internal combustion engines and includes a series of crank and crank pins with connecting rods attached thereto.

The crank pin, also called a crank journal, is the engine mechanism that connects the crankshaft to the connecting rod of each cylinder. The crank pin has a cylindrical surface so that it can rotate about a big end of the connecting rod.

The supply of lubrication oil to the crank pin, or crank pin journal is done through the crankshaft. To improve the oil supply to the crank pin journal, a hydraulic pump capacity can be increased, but we have discovered that this can increase friction loss and adversely affect engine fuel efficiency.

The above information disclosed in this Background section is only for enhancement of understanding of the background of the present disclosure, and therefore it may contain information that does not form the prior art that is already known to a person of ordinary skill in the art.

### SUMMARY

The present disclosure provides a crankshaft oil supply structure capable of smooth oil supply.

In one form of the present disclosure, a crankshaft oil supply structure may include: an upper engine block having upper end saddles positioned at both ends thereof and an upper crank saddle positioned between the upper end saddles; a lower engine block formed with a plurality of lower crank saddle; an upper end bearing formed with an end bearing hole and mounted on each of the upper end saddles; an upper main bearing formed with at least one main bearing hole and mounted on the upper crank saddle; a lower bearing mounted on each lower crank saddle of the plurality of lower crank saddles; and a crankshaft formed with an end journal supported by the upper end bearing, a main bearing journal supported by the upper main bearing, and a crank pin journal, wherein the at least one main bearing hole is larger than the end bearing hole.

The at least one main bearing hole may be a slotted hole formed along a circumferential direction of the upper main bearing.

The at least one main bearing hole may include a first main bearing hole and a second main bearing hole.

The crankshaft oil supply structure may further include a first saddle groove that is formed on an inner circumferential surface of the upper crank saddle along a circumferential direction of the upper main bearing.

The crankshaft oil supply structure may further include a second saddle groove that is formed on an inner circumferential surface of at least one upper end saddle among the upper end saddles along a circumferential direction of the upper end bearing.

The crankshaft oil supply structure may further include a main bearing groove having a predetermined width formed along a circumferential direction inside the upper main bearing.

The main bearing groove may be formed to connect both ends of the upper main bearing.

In one form, the upper end bearing is formed with an end bearing groove having a narrower width than a width of the main bearing groove, and the end bearing groove is formed on an inner circumferential surface of the upper end bearing along a circumferential direction of the upper end bearing.

The end bearing groove may be formed in a predetermined angle range from one end of the upper end bearing along the circumferential direction of the upper end bearing.

The end bearing groove may include a first end groove having a constant depth, and a second end groove whose depth becomes shallow along the circumferential direction of the upper end bearing.

The crankshaft oil supply structure may further include a lower bearing groove that may be formed on an inner circumferential surface of the lower bearing, and a depth the lower bearing groove increases toward an end of the lower bearing.

The crankshaft oil supply structure may further include a crank pin oil supply passage that is formed in the crankshaft to communicate with the main bearing journal and the crank pin journal.

In another form, a crankshaft oil supply structure may include: an upper engine block having upper end saddles positioned at both ends thereof and a first crank saddle and a second crank saddle which are positioned between the upper end saddles; a lower engine block formed a plurality of lower crank saddles; an upper end bearing formed with an end bearing hole and mounted on each of the upper end saddles; a first main bearing and a second main bearing each having a main bearing hole and respectively mounted on the first crank saddle and the second crank saddle; a lower bearing mounted on each lower crank saddle of the plurality of lower crank saddles; and a crankshaft formed with an end journal supported by the upper end bearing, a first main bearing journal supported by the first main bearing, a second main bearing journal supported by the second main bearing, and a crank pin journal. In particular, the crankshaft is formed with a crank pin oil supply passage to communicate with the first main bearing journal and the crank pin journal, and the main bearing hole may be larger than the end bearing hole.

The main bearing hole may be a slotted hole formed along a circumferential direction of the first main bearing and the second main bearing respectively.

The main bearing hole may be formed a first main bearing hole and a second main bearing hole.

The crankshaft oil supply structure may further include a first saddle groove which is formed on an inner circumferential surface of each of the first crank saddle and the second crank saddle along a circumferential direction of the first main bearing and the second main bearing respectively.

The crankshaft oil supply structure may further include a second saddle groove which is formed on an inner circumferential surface of at least one upper end saddle among the upper end saddles along a circumferential direction of the upper end bearing.

The crankshaft oil supply structure may further include a main bearing groove having a predetermined width formed along a circumferential direction respectively inside the first main bearing and the second main bearing, and wherein the main bearing groove may be formed to connect both ends of the first and the second main bearings.

In another form, the upper end bearing is formed with an end bearing groove having a narrower width than a width of the main bearing groove, and the end bearing groove is formed on an inner circumferential surface of the upper end bearing along a circumferential direction of the upper end bearing. In other form, the end bearing groove may be formed in a predetermined angle range from one end of the upper end bearing along the circumferential direction of the upper end bearing.

The crankshaft oil supply structure may further include a lower bearing groove formed on an inner circumferential surface of the lower bearing, and a depth of the lower bearing groove increases toward an end of the lower bearing.

According to an exemplary form of the present disclosure, oil supply to the crankshaft and the crank pin journal can be smoothed by dualizing the oil supply according to the position of the crankshaft bearing.

According to an exemplary form of the present disclosure, since the oil supply according to the position of the crankshaft bearing is dualized so that an appropriate oil supply is possible without increasing an oil gallery capacity.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an upper engine block applicable of a crankshaft oil supply structure according to an exemplary form of the present disclosure;

FIG. 2 is a perspective view of a lower engine block applicable of a crankshaft oil supply structure according to an exemplary form of the present disclosure;

FIG. 3 is a bottom plan view of an upper engine block applicable to a crankshaft oil supply structure in one form of the present disclosure;

FIG. 4 is a cross-sectional view along line IV-IV of FIG. 3;

FIGS. 5A, is a cross-sectional view of an upper end bearing applicable to a crankshaft oil supply structure according to an exemplary form of the present disclosure;

FIGS. 5B and 5C are perspective views showing the upper end bearing in FIG. 5A;

FIG. 6 is a perspective view of an upper main bearing applicable to a crankshaft oil supply structure according to an exemplary form of the present disclosure;

FIG. 7 is a perspective view of a lower bearing applicable to a crankshaft oil supply structure according to an exemplary form of the present disclosure;

FIG. 8 is a drawing showing a crankshaft applicable to a crankshaft oil supply structure according to an exemplary form of the present disclosure;

FIG. 9 is a cross-sectional view showing oil supply of an end bearing applicable to a crankshaft oil supply structure according to an exemplary form of the present disclosure;

FIG. 10 is a cross-sectional view showing oil supply of a main bearing applicable to a crankshaft oil supply structure according to an exemplary form of the present disclosure; and

FIG. 11 is a table showing changes in the oil pressure of a crankshaft oil supply structure according to an exemplary form of the present disclosure and an oil supply structure of a general crankshaft.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, only certain exemplary forms of the present disclosure have been shown and described, simply by way of illustration.

As those skilled in the art would realize, the described forms may be modified in various different ways, all without departing from the spirit or scope of the present disclosure

Parts indicated by the same reference number throughout the specification mean the same constituent elements.

In the drawings, the thickness of layers, films, panels, regions, etc., are exaggerated for clarity.

When a part of a layer, film, region, plate, etc. is said to be “above” another part, this includes not only directly above the other part but also another part in the middle.

In contrast, when an element is referred to as being “directly on” another element, there are no intervening elements present.

Throughout the specification and the claims, unless explicitly described to the contrary, the word “comprise” and variations such as “comprises” or “comprising”, will be understood to imply the inclusion of stated elements but not the exclusion of any other elements.

An exemplary form of the present disclosure will hereinafter be described in detail with reference to the accompanying drawings.

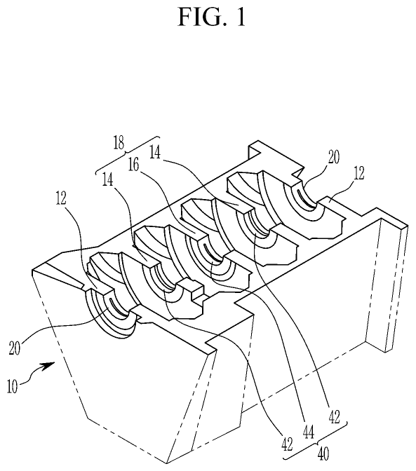

FIG. 1 is a perspective view of an upper engine block applicable of a crankshaft oil supply structure according to an exemplary form of the present disclosure.

Referring to FIG. 1, an upper engine block 10, which can be applied to a crankshaft oil supply structure according to an exemplary form of the present disclosure, has a saddle capable of mounting a crank bearing.

Upper end saddle 12 is formed at both ends of the upper engine block 10, and an upper crank saddle 18 is formed between the end saddles 12.

Upper end bearing 20 is mounted on the upper end saddle 12, and an upper main bearing 40 is mounted on the upper crank saddle 18, respectively.

In the drawing, an engine that can be applied to the crankshaft oil supply structure according to an exemplary form of the present disclosure is illustrated as a serial four-cylinder engine, but is not limited thereto, and various types of engines, for example, an engine including an end saddle and a crank saddle supporting a crankshaft can be applied.

Hereinafter, for better comprehension an engine that can be applied to the crankshaft oil supply structure according to an exemplary form of the present disclosure will be described as a serial four-cylinder engine.

The upper crank saddle 18 may include a second crank saddle 16 formed between first crank saddles 14. And a first main bearing 42 and a second main bearing 44 may be mounted on the first crank saddle 14 and the second crank saddle 16, respectively.

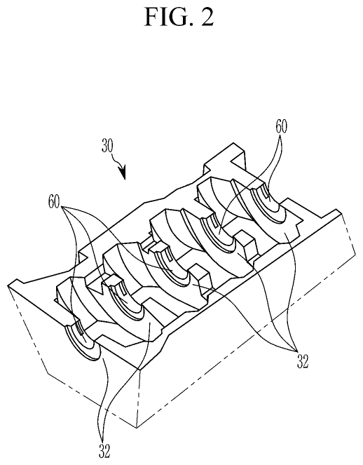

FIG. 2 is a perspective view of a lower engine block applicable of a crankshaft oil supply structure according to an exemplary form of the present disclosure.

Referring to FIG. 2, a plurality of lower crank saddles 32 is formed in a lower engine block 30 that can be applied to the crankshaft oil supply structure according to the exemplary form of the present disclosure. The lower crank saddle 32 may correspond to the upper end saddle 12 and the upper crank saddle 18, respectively. A lower bearing 60 may be mounted on the lower crank saddle 32, respectively.

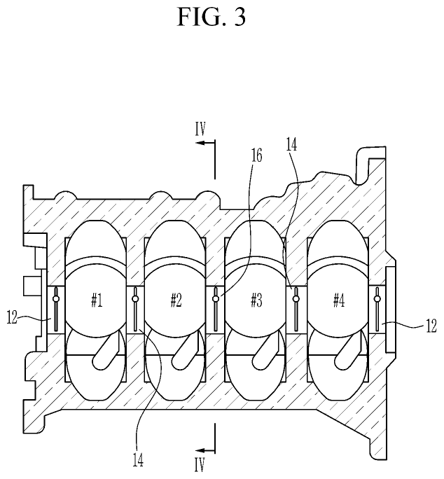

FIG. 3 is a bottom plan view of an upper engine block applicable to a crankshaft oil supply structure according to one form of the present disclosure.

Referring to FIG. 3, the upper end saddles 12 may be formed at both ends of the upper engine block 10, the first crank saddles 14 may be formed between the end saddles 12, and the second crank saddle 16 may be formed between the first crank saddles 14.

In FIG. 3, an engine that can be applied to a crankshaft oil supply structure according to an exemplary form of the present disclosure is shown as a serial four-cylinder engine including first, second, third, and fourth cylinders (#1, #2, #3, #4), however, but is not limited thereto.

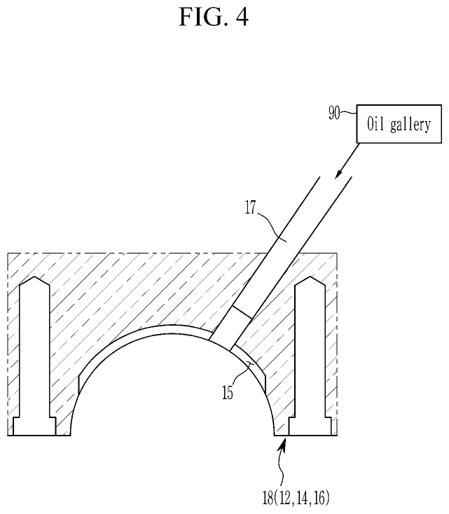

FIG. 4 is a cross-sectional view along line IV-IV of FIG. 3.

Referring to FIG. 4, a saddle groove 15 may be formed on an inner circumferential surface of the upper crank saddle 18 along a circumferential direction of the upper main bearing. That is, the saddle groove 15 may be formed in the first crank saddle 14 and the second crank saddle 16, respectively. Oil supplied from an oil gallery 90 can be supplied to the upper main bearing 40 through a saddle oil passage 17 formed in the upper engine block 10 and the saddle groove 15. The saddle groove 15 can reduce or minimize the cross-section change on the oil supply route and suppress the oil pressure drop. In addition, a saddle groove 15 is also formed an inner circumferential surface of the upper end saddle 12 along a circumferential direction of the upper end bearing to reduce or minimize the cross-section change on the oil supply route, thereby suppressing the oil pressure drop.

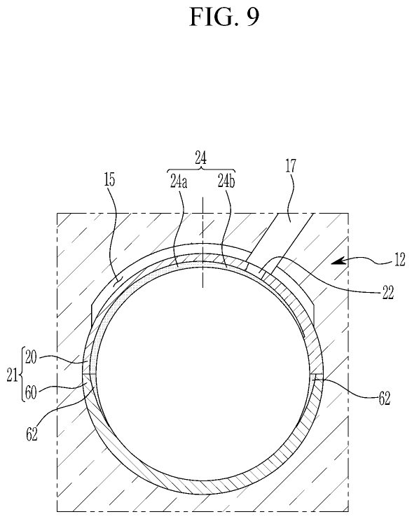

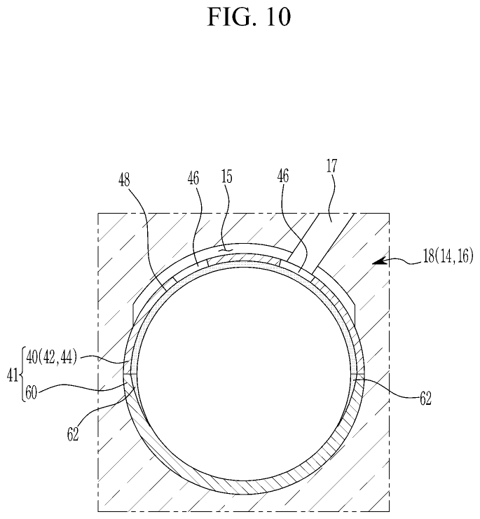

Referring to FIG. 4, FIG. 9 and FIG. 10, the saddle groove 15 may be formed along the circumferential direction of the upper end bearing 20 and the upper main bearing 40.

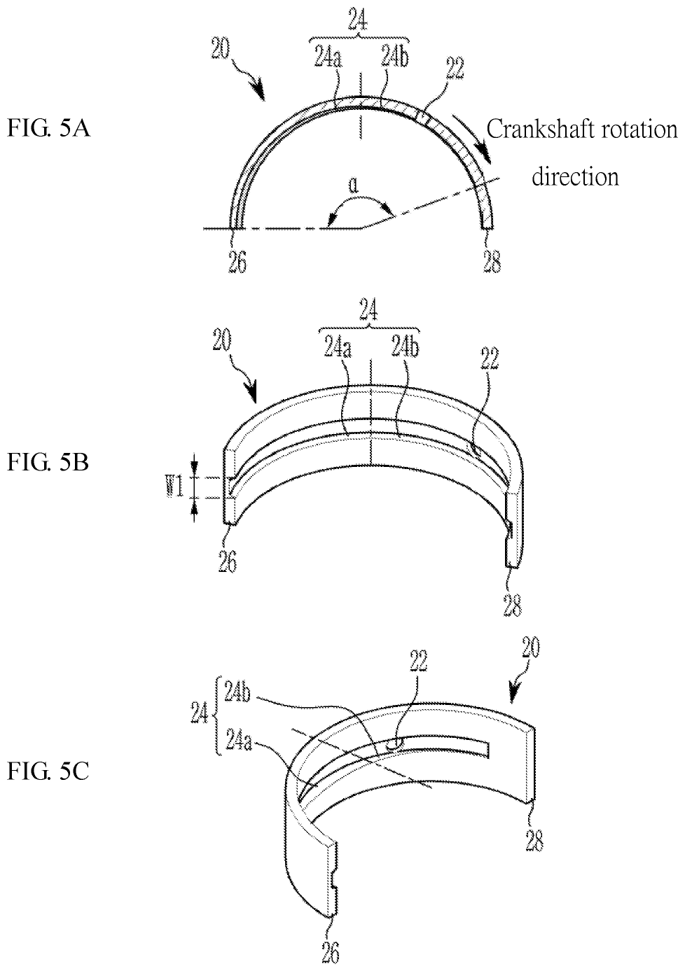

FIGS. 5A, 5B and 5C are drawings respectively showing an upper end bearing applicable to a crankshaft oil supply structure according to an exemplary form of the present disclosure.

Referring to FIGS. 5A-5C, an end bearing hole 22 may be formed in the upper end bearing 20, and an end bearing groove 24 may be formed in the upper end bearing 20 along its circumferential direction.

Referring to FIG. 5A, the end bearing groove 24 may be formed on an inner circumferential surface of the upper end bearing in a predetermined angle (α) range from one end 26 along the circumferential direction of the upper end bearing 20. That is, the end bearing groove 24 is not formed from the one end 26 to the other end 28 inside the upper end bearing 20. Instead, the end bearing groove 24 is formed within the predetermined angle (α) range in the circumferential direction. So that while the oil supplied from the saddle oil passage 17 is smoothly supplied into the upper end bearing 20, it is possible to reduce or minimize the amount of oil leaking. Cooling and lubrication performance improves when the appropriate oil is supplied to the upper end bearing 20 and the lower bearing 60, but when more oil is supplied to the end bearing groove 24, the amount of leakage in the bearing increases, and thus fuel efficiency can get worse. The end bearing groove 24 is formed at about 160 degrees from the one end 26 to the other end 28 of the upper end bearing 20 to suppress oil pressure waste. As shown in the drawing, the end bearing groove 24 is not formed on the other end 28 provided in the rotating direction of the crankshaft, so that the excessive oil supply can be suppressed with the lower bearing 60.

The end bearing groove 24 may include a first end groove 24a having a constant depth and a second end groove 24b whose depth is shallow along its circumferential direction.

That is, if the volume of the oil supply route changes rapidly, cavitation may occur. And if the end bearing groove is formed on the entire inside of the upper end bearing 20, leakage increases. But according to the crankshaft oil supply structure of the exemplary form of the present disclosure, proper oil supply is possible and oil leakage can be suppressed.

The end bearing groove 24 may have a predetermined width W1.

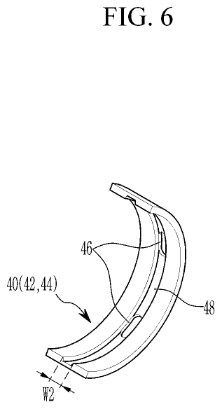

FIG. 6 is a perspective view of an upper main bearing applicable to a crankshaft oil supply structure according to an exemplary form of the present disclosure.

A main bearing hole 46 may be formed in the upper main bearing 40. The main bearing hole 46 may be formed larger than the end bearing hole 22. Here, the meaning that the main bearing hole 46 is formed larger than the end bearing hole 22 also means that the main bearing hole 46 is larger than the end bearing hole 22 in size as well as the main bearing hole 46 is more in number than the end bearing hole 22.

The main bearing hole 46 may be a slit (slotted hole) formed along the circumferential direction of the upper main bearing 40. In addition, the main bearing hole 46 may be formed at least two holes (e.g., a first main bearing hole and a second main bearing hole). That is, although two main bearing holes 46 are shown in the drawing, three or more holes may be formed.

In one form, a main bearing groove 48 having a predetermined width W2 may be formed on the inner circumferential surface of the upper main bearing 40 along its circumferential direction. The width W1 of the end bearing groove 24 may be narrower than the width W2 of the main bearing groove 48. That is, since the width W2 of the main bearing groove 48 is formed wider than the width W1 of the end bearing groove 24, relatively more oil supply is possible to the main bearing groove 48 than the end bearing groove 24.

The main bearing groove 48 may be formed to connect both ends of the upper main bearing 40. That is, the main bearing groove 48 is formed to connect the entire inner side of the upper main bearing 40, so that more oil can be supplied to the upper main bearing 40 than the upper end bearing 20.

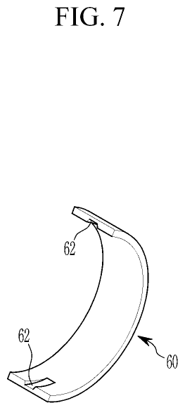

FIG. 7 is a perspective view of a lower bearing applicable to a crankshaft oil supply structure according to an exemplary form of the present disclosure.

Referring to FIG. 7, a lower bearing groove 62 may be formed on an inner circumferential surface of the lower bearing 60. The lower bearing groove 62 is formed on the inner circumferential surface of the lower bearing 60 to induce oil supply to the inside of the lower bearing 60 while preventing excessive oil from being supplied and leaking. For example, the lower bearing groove 62 may be formed about 15 degrees from both ends of the lower bearing 60, but is not limited in addition. Referring to FIG. 9, the lower bearing groove 62 may be a shape whose depth becomes deeper in the direction of its tip, and it can reduce or minimize the cross-section change on the oil supply route. That is, the depth of the end of the end bearing groove 24 and the depth of the end of the lower bearing groove 62 are formed to be the same, thereby reducing or minimizing the cross-section change on the oil supply route.

In the drawing, two lower bearing grooves 62 are shown formed at both ends of the lower bearing 60, but are not limited thereto. That is, only the lower bearing groove 62 shown on the left side of FIG.9 is formed to reduce or minimize the cross-section change on the oil supply route.

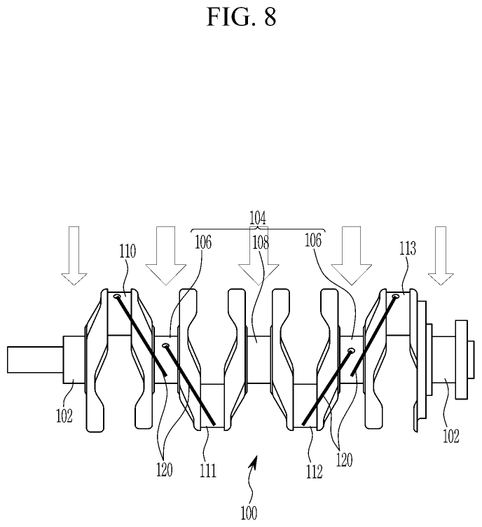

FIG. 8 is a drawing showing a crankshaft applicable to a crankshaft oil supply structure according to an exemplary form of the present disclosure.

Referring to FIG. 8, the engine that can be applied to the crankshaft oil supply structure according to an exemplary form of the present disclosure may include crankshaft 100, and the crankshaft 100 includes an end journal 102 supported by the upper end bearing 20, a main bearing journal 104 supported by the upper main bearing 40, and crank pin journals 110, 111, 112, and 113.

The main bearing journal 104 may include a first main bearing journal 106 supported by the first main bearing 42 and a second main bearing journal 108 supported by the second main bearing 44.

A crank pin oil supply passage 120 may be formed in the crankshaft 100 to communicate with the main bearing journal 104 and the crank pin journals 110, 111, 112, and 113 respectively.

That is, the crank pin oil supply passage 120 may be formed to communicate with the first main bearing journal 106 and the crank pin journal 110, 111, 112, and 113 respectively. In drawing, the first main bearing journal 106 on the left communicates with the crank pin journals 110, and 111 on the first and second cylinders #1 and #2, and the first main bearing journal 106 on the right communicates with the crank pin journals 112, and 113 on the third and fourth cylinders #3 and #4, but is not limited thereto.

FIG. 9 is a cross-sectional view showing oil supply of an end bearing applicable to a crankshaft oil supply structure according to an exemplary form of the present disclosure, and FIG. 10 is a cross-sectional view showing oil supply of a main bearing applicable to a crankshaft oil supply structure according to an exemplary form of the present disclosure.

The end journal 102 is supported by an end bearing 21, which combines the upper end bearing 20 and the lower bearing 60, and the main bearing journal 104 is supported by a main bearing 41, which combines the upper main bearing 40 and the lower bearing 60.

In FIG. 8, as indicated by the arrow, more oil is supplied to the main bearing 41 than to the end bearing 21, so it is possible to supply the oil smoothly to the crank pin journals 110, 111, 112 and 113. In addition, in the case of the second main bearing journal 108, it does not communicate with the crank pin journal, but the load of the crankshaft 100 is concentrated and a relatively large oil supply may be desired.

In the crankshaft oil supply structure according to an exemplary form of the present disclosure, the second main bearing 44 may be lubricated with the same shape as the first main bearing 42 to maintain cooling and lubrication performance for the load concentration of the crankshaft 100.

The oil delivered to the main bearing combined with the first main bearing journal 106 and the lower bearing 60 is supplied to the crank pin journals 110 and 111 of the first and second cylinders #1, and #2 and to the crank pin journals112 and 113 of the third and fourth cylinders #3, and #4.

Comparing FIG. 9 and FIG. 10, the size of the main bearing hole 46 is larger than that of the end bearing hole 22 or the number is larger than that of the end bearing hole 22, so that more oil can be supplied to the main bearing 41 than the end bearing 21.

Since the width W2 of the main bearing groove 48 is relatively wider than the width W1 of the end bearing groove 24, relatively more oil supply is possible inside the main bearing 41 than the inside of the end bearing 21.

Since the length of the main bearing groove 48 is relatively longer than that of the end bearing groove 24, more oil supply is possible inside the main bearing 41.

The lower bearing groove 62 is formed partially only on the inner part of the lower bearing 60 to smoothly supply the oil to the lower bearing 60 while suppressing oil leakage.

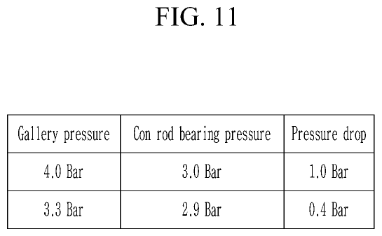

FIG. 11 is a table showing changes in the oil pressure of a crankshaft oil supply structure according to an exemplary form of the present disclosure and an oil supply structure of a general crankshaft.

As shown in FIG. 11, when the hydraulic pressure of a general oil gallery is 4.0 bar, the hydraulic pressure delivered to the crank pin journal is 3.0 bar, resulting in a pressure drop of 1.0 bar.

However, in the case of a crankshaft oil supply structure according to an exemplary form of the present disclosure, the hydraulic pressure of the oil gallery is 3.3 bar, and the hydraulic pressure delivered to the crank pin journal is 2.9 bar, resulting in a pressure drop of 0.4 bar.

That is, when the same hydraulic pressure is transmitted to the main bearing and the end bearing, the oil gallery hydraulic pressure must be maintained about 4.0 bar to deliver hydraulic pressure of about 3.0 bar to the crank pin journal. However, in the crankshaft oil supply structure according to an exemplary form, even if the oil gallery hydraulic pressure is maintained about 3.3 bar, hydraulic transmission of 2.9 bar is possible to the crank pin journal.

That is, even if the capacity of the oil gallery is reduced, an appropriate oil supply is possible with a crank pin journal.

While this present disclosure has been described in connection with what is presently considered to be practical exemplary forms, it is to be understood that the present disclosure is not limited to the disclosed forms.

<Description of symbols>

| | |
|---|---|
| 10: upper engine block | 12: upper end saddle |
| 14: first crank saddle | 15: saddle groove |
| 16: second crank saddle | 17: saddle oil passage |
| 18: upper crank saddle | 20: upper end bearing |
| 22: end bearing hole | 24: end bearing groove |
| 30: lower engine block | 32: lower crank saddle |
| 40: upper main bearing | 42: first main bearing |
| 44: second main bearing | 46: main bearing hole |
| 48: main bearing groove | 60: lower bearing |
| 62: lower bearing groove | 90: gallery |
| 100: crankshaft | 102: end journal |
| 104: main bearing journal | 106: first main bearing |
| 108: second main bearing journal | journal |
| 110, 111, 112, 113: crank pin journal | |
| 120: crank pin oil supply passage | |

What is claimed is:

1. A crankshaft oil supply structure comprising:
an upper engine block having upper end saddles positioned at both ends thereof and an upper crank saddle positioned between the upper end saddles;
a lower engine block formed with a plurality of lower crank saddle;
an upper end bearing formed with an end bearing hole and mounted on each of the upper end saddles;
an upper main bearing formed with at least one main bearing hole and mounted on the upper crank saddle;
a lower bearing mounted on each lower crank saddle of the plurality of lower crank saddles; and
a crankshaft formed with an end journal supported by the upper end bearing, a main bearing journal supported by the upper main bearing, and a crank pin journal,
wherein the at least one main bearing hole is larger than the end bearing hole.

2. The crankshaft oil supply structure of claim 1, wherein the at least one main bearing hole is a slotted hole formed along a circumferential direction of the upper main bearing.

3. The crankshaft oil supply structure of claim 2, wherein the at least one main bearing hole comprises a first main bearing hole and a second main bearing hole.

4. The crankshaft oil supply structure of claim 1, further comprising: a first saddle groove formed on an inner circumferential surface of the upper crank saddle along a circumferential direction of the upper main bearing.

5. The crankshaft oil supply structure of claim 4, further comprising: a second saddle groove formed on an inner circumferential surface of at least one upper end saddle among the upper end saddles along a circumferential direction of the upper end bearing.

6. The crankshaft oil supply structure of claim 1, further comprising: a main bearing groove having a predetermined width formed along a circumferential direction inside the upper main bearing.

7. The crankshaft oil supply structure of claim 6, wherein the main bearing groove is formed to connect both ends of the upper main bearing.

8. The crankshaft oil supply structure of claim 6, wherein the upper end bearing is formed with an end bearing groove having a narrower width than a width of the main bearing groove, and the end bearing groove is formed on an inner circumferential surface of the upper end bearing along a circumferential direction of the upper end bearing.

9. The crankshaft oil supply structure of claim 8, wherein the end bearing groove is formed in a predetermined angle range from one end of the upper end bearing along the circumferential direction of the upper end bearing.

10. The crankshaft oil supply structure of claim 9, wherein the end bearing groove comprises:
a first end groove having a constant depth; and
a second end groove whose depth becomes shallow along the circumferential direction of the upper end bearing.

11. The crankshaft oil supply structure of claim 1, wherein a lower bearing groove is formed on an inner circumferential surface of the lower bearing, and a depth of the lower bearing groove increases toward an end of the lower bearing.

12. The crankshaft oil supply structure of claim 1, wherein the crankshaft includes a crank pin oil supply passage configured to communicate with the main bearing journal and the crank pin journal.

13. A crankshaft oil supply structure comprising:
an upper engine block having upper end saddles positioned at both ends thereof and a first crank saddle and a second crank saddle which are positioned between the upper end saddles;
a lower engine block formed with a plurality of lower crank saddles;
an upper end bearing formed with an end bearing hole and mounted on each of the upper end saddles;
a first main bearing and a second main bearing each having a main bearing hole and respectively mounted on the first crank saddle and the second crank saddle;
a lower bearing mounted on each lower crank saddle of the plurality of lower crank saddles; and
a crankshaft formed with an end journal supported by the upper end bearing, a first main bearing journal supported by the first main bearing, a second main bearing journal supported by the second main bearing, and a crank pin journal,
wherein the crankshaft is formed with a crank pin oil supply passage configured to communicate with the first main bearing journal and the crank pin journal, and
wherein the main bearing hole is larger than the end bearing hole.

14. The crankshaft oil supply structure of claim 13, wherein the main bearing hole is a slotted hole formed along a circumferential direction of the first main bearing and the second main bearing respectively.

15. The crankshaft oil supply structure of claim 14, wherein the main bearing hole is formed with a first main bearing hole and a second main bearing hole.

16. The crankshaft oil supply structure of claim 13 further comprising: a first saddle groove formed on an inner circumferential surface of each of the first crank saddle and the second crank saddle along a circumferential direction of the first main bearing and the second main bearing respectively.

17. The crankshaft oil supply structure of claim 13, further comprising: a second saddle groove formed on an inner circumferential surface of at least one upper end saddle among the upper end saddles along a circumferential direction of the upper end bearing.

18. The crankshaft oil supply structure of claim 13, further comprising: a main bearing groove having a predetermined width formed along a circumferential direction respectively inside the first main bearing and the second main bearing, and
wherein the main bearing groove is formed to connect both ends of the first and the second main bearings.

19. The crankshaft oil supply structure of claim 18, wherein the upper end bearing is formed with an end bearing groove having a narrower width than a width of the main bearing groove, and the end bearing groove is formed on an inner circumferential surface of the upper end bearing along a circumferential direction of the upper end bearing, and
wherein the end bearing groove is formed in a predetermined angle range from one end of the upper end bearing along the circumferential direction of the upper end bearing.

20. The crankshaft oil supply structure of claim 13, wherein a lower bearing groove is formed on an inner circumferential surface of the lower bearing, and a depth of the lower bearing groove increases toward an end of the lower bearing.
